(19) United States
(12) Patent Application Publication
(10) Pub. No.: US 2019/0110278 A1
(43) Pub. Date: Apr. 11, 2019

(54) METHOD AND DEVICE IN UE AND BASE STATION USED FOR WIRELESS COMMUNICATION

(71) Applicant: Shanghai Langbo Communication Technology Company Limited, Shanghai (CN)

(72) Inventors: Zheng Liu, Shanghai (CN); Qi Jiang, Shanghai (CN)

(73) Assignee: Shanghai Langbo Communication Technology Company Limited, Shanghai (CN)

(21) Appl. No.: 16/152,007

(22) Filed: Oct. 4, 2018

(30) Foreign Application Priority Data
Oct. 5, 2017 (CN) 201710925951.3

(51) Int. Cl. H04W 72/04; H04W 68/00

(52) U.S. Cl. CPC H04W 72/042; H04W 72/0446; H04W 68/005

(57) ABSTRACT

The present disclosure provides a method and a device in a User Equipment (UE) and a base station used for wireless communication. The UE first receives first-type information and then detects a first signaling in X1 slots; wherein the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information. The method in the present disclosure can reduce the possibility of paging failure and improve paging capacity.

### CROSS REFERENCE TO RELATED APPLICATION

This application claims the priority benefit of Chinese Patent Application Serial Number 201710925951.3, filed on Oct. 5, 2017, the full disclosure of which is incorporated herein by reference.

### BACKGROUND

### Technical Field

The present disclosure relates to transmission schemes in wireless communication systems, and in particular to a method and a device supporting transmission of paging related information.

### Realted Art

Application scenarios of future wireless communication systems are becoming increasingly diversified, and different application scenarios have different performance requirements for systems. In order to meet different performance requirements of various application scenarios, the 3^{rd} Generation Partner Project (3GPP) Radio Access Network (RAN) #72 plenary session decided to conduct the study of New Radio (NR). The work item of NR was approved at the 3GPP RAN #75 session to standardize the NR.

In order to adapt to various different application scenes flexibly, future wireless communication systems, especially 5G NR, will support various numerologies. The various numerologies refer to various subcarrier spacing (SCS), various symbol time lengths, various Cyclic Prefix (CP) lengths, etc. In order to satisfy flexibility, spectrum efficiency, reduction of implementation complexity, and other factors, many corresponding common signals and common channels in Long Term Evolution (LTE) are designed to be configurable. Meanwhile, frame structures (including full uplink, full downlink, uplink-downlink ratio) can also be flexibly configured according to requirements or service types. However, this also brings new challenges for some other designs.

### SUMMARY

In the design of paging in LTE, the Downlink Control Information (DCI) for scheduling a Paging Channel (PCH) can appear only in fixed subframes in a particular radio frame in LTE. The design of LTE can guarantee that these subframes are permanently reserved for downlink transmission. However, in NR systems, due to the design of the flexible uplink and downlink and the self-contained frame structure, it is very difficult to ensure that fixed downlink slots are available to transmit paging scheduling. Therefore, a new design of paging is required.

It should be noted that embodiments in the UE of the present disclosure and the characteristics in the embodiments may be applied to the base station if no conflict is incurred, and vice versa. Further, the embodiments of the present disclosure and the characteristics in the embodiments may be mutually combined if no conflict is incurred

The present disclosure provides a method in a UE for wireless communication, comprising:

receiving first-type information; and

detecting a first signaling in X1 slots;

herein, the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

According to one aspect of the present disclosure, the above method is characterized in that: each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the detector of the first signaling.

According to one aspect of the present disclosure, the above method is characterized in that: the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

According to one aspect of the present disclosure, the above method further comprises:

receiving second-type information;

herein, the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows is used for determining the X1 slots among the X candidate slots.

According to one aspect of the present disclosure, the above method further comprises:

receiving a first radio signal;

herein, the first radio signal carries paging related information, and the first signaling is used for determining at least one of {occupied time-frequency resources, Modulation and Coding Scheme (MCS), subcarrier spacing of occupied subcarriers} of the first radio signal.

According to one aspect of the present disclosure, the above method further comprises:

receiving a second signaling;

herein, the first signaling is used for determining whether the second signaling is transmitted, and the second signaling indicates at least one of {occupied time-frequency resource, MCS, subcarrier spacing of occupied subcarriers} of the first radio signal.

According to one aspect of the present disclosure, the above method is characterized in that: the feature ID of the detector of the first signaling is further used for determining frequency domain resources occupied by the common search space included in the X1 slots.

The present disclosure provides a method in a base station device for wireless communication, comprising:

transmitting first-type information; and

transmitting a first signaling in X1 slots;

herein, the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

According to one aspect of the present disclosure, the above method is characterized in that: each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the detector of the first signaling.

According to one aspect of the present disclosure, the above method is characterized in that: the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

According to one aspect of the present disclosure, the above method further comprises:

transmitting second-type information;

herein, the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the X candidate slots.

According to one aspect of the present disclosure, the above method further comprises:

transmitting a first radio signal;

herein, the first radio signal carries paging related information, and the first signaling is used for determining at least one of {occupied time-frequency resources, MCS, subcarrier spacing of occupied subcarriers} of the first radio signal.

According to one aspect of the present disclosure, the above method further comprises:

transmitting a second signaling;

herein, the first signaling is used for determining whether the second signaling is transmitted, and the second signaling indicates at least one of {occupied time-frequency resource, MCS, subcarrier spacing of occupied subcarriers} of the first radio signal.

According to one aspect of the present disclosure, the above method is characterized in that: the feature ID of the detector of the first signaling is further used for determining frequency domain resources occupied by the common search space included in the X1 slots.

The present disclosure provides a UE for wireless communication. The UE comprises:

a first receiver module, to receive first-type information; and

a second receiver module, to detect a first signaling in X1 slots;

herein, the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

According to one aspect of the present disclosure, the above UE is characterized in that: each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the detector of the first signaling.

According to one aspect of the present disclosure, the above UE is characterized in that: the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

According to one aspect of the present disclosure, the above UE is characterized in that: the first receiver module further receives second-type information; wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the X candidate slots.

According to one aspect of the present disclosure, the above UE is characterized in that: the second receiver module further receives a first radio signal; wherein the first radio signal carries paging related information, and the first signaling is used for determining at least one of {occupied time-frequency resource, MCS, subcarrier spacing of occupied subcarriers} of the first radio signal.

According to one aspect of the present disclosure, the above UE is characterized in that: the second receiver module further receives a second signaling; wherein the first signaling is used for determining whether the second signaling is transmitted, and the second signaling indicates at least one of {occupied time-frequency resource, MCS, subcarrier spacing of occupied subcarriers} of the first radio signal.

According to one aspect of the present disclosure, the above UE is characterized in that: the feature ID of the detector of the first signaling is further used for determining frequency domain resources occupied by the common search space included in the X1 slots.

The present disclosure provides a base station device for wireless communication. The base station device comprises:

a first transmitter module, to transmit first-type information; and

a second transmitter module, to transmit a first signaling in X1 slots;

herein, the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

According to one aspect of the present disclosure, the above base station device is characterized in that: each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the detector of the first signaling.

According to one aspect of the present disclosure, the above base station device is characterized in that: the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

According to one aspect of the present disclosure, the above base station device is characterized in that: the first transmitter module further transmits second-type information; wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the X candidate slots.

According to one aspect of the present disclosure, the above base station device is characterized in that: the second transmitter module further transmits a first radio signal; wherein, the first radio signal carries paging related information, and the first signaling is used for determining at least one of {occupied time-frequency resource, MCS, subcarrier spacing of occupied subcarriers} of the first radio signal.

According to one aspect of the present disclosure, the above base station device is characterized in that: the second transmitter module further transmits a second signaling; wherein the first signaling is used for determining whether the second signaling is transmitted, and the second signaling indicates at least one of {occupied time-frequency resource, MCS, subcarrier spacing of occupied subcarriers} of the first radio signal.

According to one aspect of the present disclosure, the above base station device is characterized in that: the feature ID of the detector of the first signaling is further used for determining frequency domain resources occupied by the common search space included in the X1 slots.

In one embodiment, the design in the present disclosure has the following benefits.

The slots in which a UE detects paging is adapted to the time-domain configuration of the common search space. The problem of paging failure due to the missing of common search space is avoided.

The frequency of paging detections and the time domain density of the common search space are correlated, so that the distribution of paging occasions can be optimized. Optimal configuration is realized between the power consumption and the capacity of the UE.

The periodicity of Discontinuous Reception (DRX) of the UE is a positive integer multiple of the configured periodicity of the common search space. The design of paging is simplified.

### BRIEF DESCRIPTION OF THE DRAWINGS

Other features, purposes and advantages of the present disclosure will become more apparent from the detailed description of non-restrictive embodiments taken in conjunction with the following drawings.

FIG. 1 is a flowchart illustrating the transmission of first-type information and a first signaling according to one embodiment of the present disclosure.

FIG. 2 is a diagram illustrating a network architecture according to one embodiment of the present disclosure.

FIG. 3 is a diagram illustrating a radio protocol architecture of a user plane and a control plane according to one embodiment of the present disclosure.

FIG. 4 is a diagram illustrating a base station device and a UE according to one embodiment of the present disclosure.

FIG. 5 is a flowchart illustrating the transmission of a radio signal according to one embodiment of the present disclosure.

FIG. 6 is a diagram illustrating a relationship among X1 slots, X slots and Y slots according to one embodiment of the present disclosure.

FIG. 7 is a diagram illustrating a relationship between a target time window and K1 first-type time windows according to one embodiment of the present disclosure.

FIG. 8 is a diagram illustrating a relationship between K1 first-type time windows and K2 second-type time windows according to one embodiment of the present disclosure.

FIG. 9 is a diagram illustrating a relationship among a first signaling, a second signaling and a first radio signal according to one embodiment of the present disclosure.

FIG. 10 is a structure block diagram illustrating a processing device in a UE according to one embodiment of the present disclosure.

FIG. 11 is a structure block diagram illustrating a processing device in a base station according to one embodiment of the present disclosure.

### DESCRIPTION OF THE EMBODIMENTS

The technical scheme of the present disclosure is described below in further details in conjunction with the drawings. It should be noted that the embodiments in the present disclosure and the characteristics of the embodiments may be arbitrarily combined if no conflict is caused.

### Embodiment 1

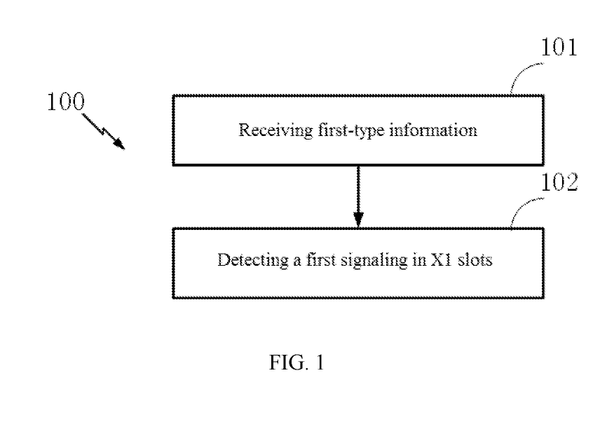

Embodiment 1 illustrates a flowchart of the transmission of first-type information and a first signaling according to one embodiment of the present disclosure, as shown in FIG. 1. In FIG. 1, each box represents a step. In Embodiment 1, the UE in the present disclosure first receives first-type information and then detects a first signaling in X1 slots; wherein the first-type information is used for determining Y slots, a common search space is reserved within each of the Y slots, each slot of the X1 slots belongs to one of the Y slots, a feature ID of a detector of the first signaling is used for determining the X1 slots among the Y slots, the Y is greater than the X1, both the X1 and the Y are positive integers, and the first signaling is used for determining paging related information

In one embodiment, one slot other than the Y slots is partially or fully reserved for downlink transmission.

In one embodiment, a complete Common Search Space (CSS) is reserved within each of the Y slots.

In one embodiment, a common search space is reserved only within each of the Y slots.

In one embodiment, any one slot partially or fully served for downlink transmission, other than the Y slots, does not include a common search space.

In one embodiment, a common search space is reserved within each of the Y slots refers that the UE can assume that a particular part of resources in the Y slots includes a common search space.

In one embodiment, each slot of the Y slots is a 5G NR slot with a given subcarrier spacing and a given Cyclic Prefix (CP) length.

In one embodiment, each slot of the Y slots is a 5G NR min-slot with a given subcarrier spacing and a given CP length.

In one embodiment, each slot of the X1 slots is a Paging Occasion (PO).

In one embodiment, any two slots of the X1 slots are transmitted via different antenna port groups, and the antenna port group includes a positive integer number of antenna ports.

In one embodiment, any two slots of the X1 slots are transmitted via different analog beams.

In one embodiment, transmissions respectively within any two slots of the X1 slots are Quasi Co-Located (QCLed) with different Synchronization Signal Broadcast Blocks (SS Blocks).

In one embodiment, the common search space refers to a common search space for searching Physical Downlink Control Channel (PDCCH) candidates.

In one embodiment, the common search space refers to a common search space for searching a PDCCH in order to acquire Downlink Control Information (DCI).

In one embodiment, the common search space refers to a common search space that is reserved for a DCI scheduling paging related information.

In one embodiment, the common search space is a Type-I common search space.

In one embodiment, the common search space refers to a common search space that can be used by DCI for schedulingpaging related information.

In one embodiment, the common search space refers to a common search space assumed by the UE that is reserved for a DCI scheduling paging related information.

In one embodiment, detecting the first signaling in the X1 slots is realized through the blind decoding conducted by the UE.

In one embodiment, detecting the first signaling in the X1 slots is realized by the UE performing channel decoding on the assumption of the first signaling and then verifying Cyclic Redundancy Check (CRC).

In one embodiment, detecting the first signaling in the X1 slots is realized through the energy detection of the first signaling.

In one embodiment, the first-type information is transmitted through a higher layer signaling.

In one embodiment, the first-type information includes partial or all of the fields in one RRC signaling.

In one embodiment, the first-type information includes the Information Elements (IEs) in one RRC signaling.

In one embodiment, the first-type information includes partial or all of the IEs in one RRC signaling.

In one embodiment, the first-type information includes partial or all of the IEs in one Master Information Block (MIB).

In one embodiment, the first-type information is transmitted through a Physical Broadcast Channel (PBCH).

In one embodiment, the first-type information includes partial or all of the IEs in one System Information Block (SIB).

In one embodiment, the first-type information includes partial or all of the IEs in one Remaining System Information (RMSI).

In one embodiment, the first-type information is transmitted through a Physical Downlink Shared Channel (PDSCH).

In one embodiment, the first signaling is a physical layer signaling.

In one embodiment, the first signaling includes a DCI.

In one embodiment, the first signaling includes a wake-up signal.

In one embodiment, the first signaling is carried by a bit block that is subjected to channel coding.

In one embodiment, the first signaling is carried by a sequence.

In one embodiment, the first signaling is carried by the transmission of a signal.

In one embodiment, the first signaling includes a DCI with a CRC scrambled by a Paging Radio Network Temporary Identity (P-RNTI).

In one embodiment, the feature ID is an International Mobile Subscriber Identification Number (IMSI).

In one embodiment, the feature ID is an SAE (System Architecture Evolution)-Temporary Mobile Subscriber Identity (S-TMSI).

In one embodiment, the feature ID of the detector of the first signaling is used for determining X1 index values, the Y slots are indexed in order, and the X1 slots are the slots in the Y slots that are corresponding to the X1 index values respectively.

In one embodiment, none of the slots other than the Y slots include a common search space.

In one embodiment, a receiver of the first-type information assumes that any one slot partially or fully served for downlink transmission, other than the Y slots, does not include a common search space.

In one embodiment, the paging related information includes at least one of {paging record, whether system information changes, whether to receive information from earthquake & tsunami warning systems, whether to receive information from commercial mobile alarm services, whether to transmit beam reports}.

In one embodiment, the first-type information is used by the UE to determine the Y slots.

In one embodiment, the first-type information indicates the Y slots.

In one embodiment, the first signaling is used by the UE to determine the paging related information.

In one embodiment, the first signaling is used by the UE to determine the paging related information indirectly.

In one embodiment, the first signaling indicates the paging related information.

### Embodiment 2

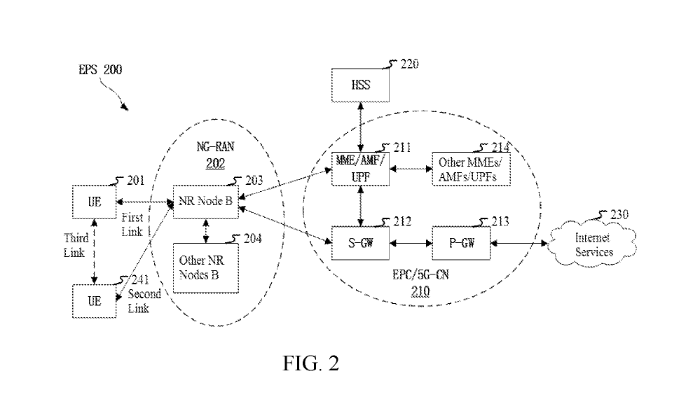

Embodiment 2 illustrates an example of a diagram of a network architecture according to the present disclosure, as shown in FIG. 2. FIG. 2 is a diagram illustrating a network architecture 200 of NR 5G Long-Term Evolution (LTE), Long-Term Evolution Advanced (LTE-A) systems. The NR 5G or LTE network architecture 200 may be called an Evolved Packet System (EPS) 200. The EPS 200 may include one or more UEs 201, an NG-RAN 202, an Evolved Packet Core/5G-Core Network (EPC/5G-CN) 210, a Home Subscriber Server (HSS) 220 and an Internet Service 230. The EPS may be interconnected with other access networks. For simple description, the entities/interfaces are not shown. As shown in FIG. 2, the EPS provides packet switching services. Those skilled in the art are easy to understand that various concepts presented throughout the present disclosure can be extended to networks providing circuit switching services or other cellular networks. The NG-RAN includes an NR node B (gNB) 203 and other gNBs 204. The gNB 203 provides UE 201 oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Basic Service Set (BSS), an Extended Service Set (ESS), a TRP or some other appropriate terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistants (PDAs), Satellite Radios, Global Positioning Systems (GPSs), multimedia devices, video devices, digital audio player (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 includes an MME/AMF/UPF 211, other MMEs/AMFs/UPFs 214, a Service Gateway (S-GW) 212 and a Packet Data Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet service 230. The Internet service 230 includes IP services corresponding to operators, specifically including Internet, Intranet, IP Multimedia Subsystems (IMSs) and Packet Switching Streaming Services (PSSs).

In one embodiment, the UE 201 corresponds to the UE in the present disclosure.

In one embodiment, the gNB 203 corresponds to the base station in the present disclosure.

In one embodiment, the UE 201 supports the blind decoding of the first signaling.

In one embodiment, the UE 201 supports the reception of paging related information.

In one embodiment, the gNB 203 supports the transmission of paging of the UE.

### Embodiment 3

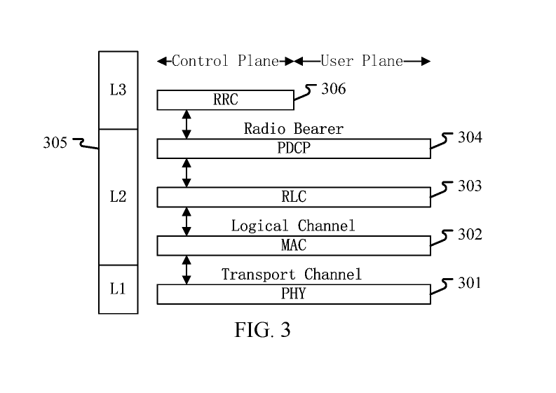

Embodiment 3 illustrates an embodiment of a radio protocol architecture of a user plane and a control plane according to the present disclosure, as shown in FIG. 3. FIG. 3 is a diagram illustrating an embodiment of a radio protocol architecture of a user plane and a control plane. In FIG. 3, the radio protocol architecture of a UE and a base station device (gNB or eNB) is represented by three layers, which are a layer 1, a layer 2 and a layer 3 respectively. The layer 1 (L1) is the lowest layer and performs signal processing functions of various PHY layers. The layer 1 is called PHY 301 in this paper. The layer 2 (L2) 305 is above the PHY 301, and is in charge of the link between the UE and the gNB via the PHY 301. In the user plane, the L2 305 includes a Medium Access Control (MAC) sublayer 302, a Radio Link Control (RLC) sublayer 303, and a Packet Data Convergence Protocol (PDCP) sublayer 304. All the three sublayers terminate at the gNB of the network side. Although not described in FIG. 3, the UE may include several higher layers above the L2 305, such as a network layer (i.e. IP layer) terminated at a P-GW of the network side and an application layer terminated at the other side of the connection (i.e. a peer UE, a server, etc.). The PDCP sublayer 304 provides multiplexing among variable radio bearers and logical channels. The PDCP sublayer 304 also provides a header compression for a higher-layer packet so as to reduce a radio transmission overhead. The PDCP sublayer 304 provides security by encrypting a packet and provides support for UE handover between gNBs. The RLC sublayer 303 provides segmentation and reassembling of a higher-layer packet, retransmission of a lost packet, and reordering of a packet to as to compensate the disordered receiving caused by Hybrid Automatic Repeat Request (HARQ). The MAC sublayer 302 provides multiplexing between logical channels and transport channels. The MAC sublayer 302 is also responsible for allocating between UEs various radio resources (i.e., resource block) in a cell. The MAC sublayer 302 is also in charge of HARQ operation. In the control plane, the radio protocol architecture of the UE and the gNB is almost the same as the radio protocol architecture in the user plane on the PHY 301 and the L2 305, but there is no header compression for the control plane. The control plane also includes a Radio Resource Control (RRC) sublayer 306 in the layer 3 (L3). The RRC sublayer 306 is responsible for acquiring radio resources (i.e. radio bearer) and configuring the lower layers using an RRC signaling between the gNB and the UE.

In one embodiment, the radio protocol architecture in FIG. 3 is applicable to the UE in the present disclosure.

In one embodiment, the radio protocol architecture in FIG. 3 is applicable to the base station device in the present disclosure.

In one embodiment, the first-type information in the present disclosure is generated by the RRC 306.

In one embodiment, the second-type information in the present disclosure is generated by the RRC 306.

In one embodiment, the first signaling in the present disclosure is generated by the PHY 301.

In one embodiment, the second signaling in the present disclosure is generated by the PHY 301.

In one embodiment, the first radio signal in the present disclosure is generated by the RRC 306.

### Embodiment 4

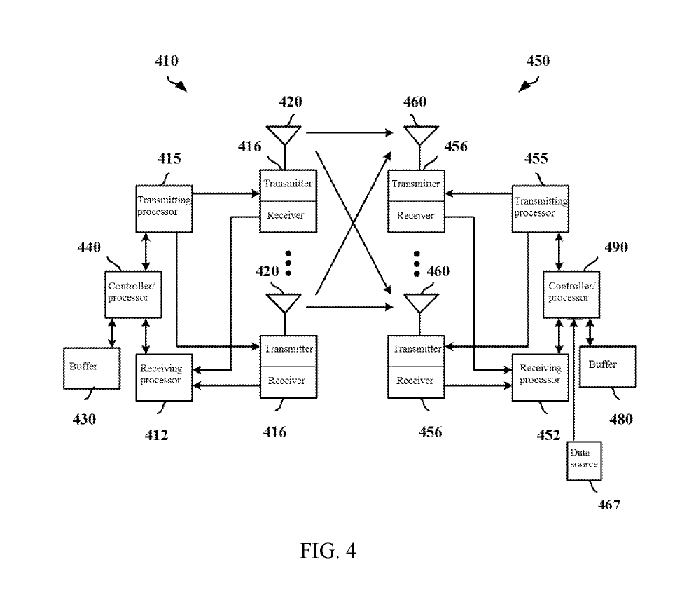

Embodiment 4 illustrates a diagram of a base station device and a given UE according to the present application, as shown in FIG. 4. FIG. 4 is a block diagram of a gNB 410 in communication with a UE 450 in an access network.

The UE 450 includes a controller/processor 490, a memory 480, a receiving processor 452, a transmitter/receiver 456, a transmitting processor 455, and a data source 467. The transmitter/receiver 456 includes an antenna 460. The data source 467 provides a packet from a higher layer packet to the controller/processor 490. The controller/processor 490 provides header compression/decompression, encryption/decryption, packet segmentation and reordering, multiplexing/de-multiplexing between a logical channel and a transport channel, to implement the L2 protocol used for the user plane and the control plane. The packet from a higher layer may include data or control information, for example, DL-SCH or UL-SCH. The transmitting processor 455 performs signal transmitting processing functions of an L1 layer (that is, PHY), including encoding, interleaving, scrambling, modulation, power control/allocation, precoding, generation of physical layer control signaling, etc. The receiving processor 452 performs signal receiving processing functions of the L1 layer (that is, PHY), including decoding, de-interleaving, descrambling, demodulation, de-precoding, extraction of physical layer control signaling, etc. The detection of the first signaling in the present disclosure is completed at the receiving processor 452. The transmitter 456 is configured to convert a baseband signal provided by the transmitting processor 455 into a radio-frequency signal and transmit the radio-frequency signal via the antenna 460. The receiver 456 is configured to convert a radio-frequency signal received via the antenna 460 into a baseband signal and provide the baseband signal to the receiving processor 452.

The base station device 410 may include a controller/processor 440, a memory 430, a receiving processor 412, a transmitter/receiver 416 and a transmitting processor 415. The transmitter/receiver 416 includes an antenna 420. A packet from a higher layer is provided to the controller/processor 440. The controller/processor 440 provides header compression/decompression, encryption/decryption, packet segmentation and reordering, multiplexing/de-multiplexing between a logical channel and a transport channel, to implement the L2 protocol used for the user plane and the control plane. The packet from a higher layer may include data or control information, for example, DL-SCH or UL-SCH. The transmitting processor 455 performs signal transmitting processing functions of an L1 layer (that is, PHY), including encoding, interleaving, scrambling, modulation, power control/allocation, precoding, generation of physical layer control signaling (including PBCH, PDCCH, PHICH, PCFICH, reference signal), etc. The first signaling in the present disclosure is generated by the transmitting processor 415. The receiving processor 412 performs signal receiving processing functions of the L1 layer (that is, PHY), including decoding, de-interleaving, descrambling, demodulation, de-precoding, extraction of physical layer control signaling, etc. The transmitter 416 is configured to convert a baseband signal provided by the transmitting processor 415 into a radio-frequency signal and transmit the radio-frequency signal via the antenna 420. The receiver 416 is configured to convert a radio-frequency signal received via the antenna 420 into a baseband signal and provide the baseband signal to the receiving processor 412.

In Downlink (DL) transmission, a packet DL-SCH from a higher layer, which includes the first-type information, the second-type information and the first radio signal in the present application, is provided to the controller/processor 440. The controller/processor 440 performs functions of a layer 2. In downlink transmission, the controller/processor 440 provides header compression, encryption, packet segmentation and reordering, multiplexing between a logical channel and a transport channel, and radio resource allocation for the UE 450 based on various priorities. The controller/processor 440 is also in charge of HARQ operation, retransmission of a lost packet, and a signaling to the UE 450. The transmitting processor 415 performs signal processing functions of the layer 1 (that is, PHY). The signal processing function includes decoding and interleaving, so as to ensure an FEC (Forward Error Correction) and a demodulation corresponding to a modulation scheme (i.e., BPSK, QPSK, etc.) at the UE 450 side. The modulated signals are divided into parallel streams. Each of the parallel streams is mapped into a corresponding subcarrier of multi-carriers and/or multi-carrier symbol. Then the transmitting processor 415 maps the parallel stream into the antenna 420 via the transmitter 416 to as to transmit the parallel stream in the form of Radio Frequency (RF) signals. The first signaling and the second signaling in the present disclosure are mapped into the antenna 420 by the transmitting processor 415 via the transmitter 416, so as to be transmitted out in the form of RF signals. At the receiving side, every receiver 456 receives a radio frequency signal via the corresponding antenna 460. Every receiver 456 recovers the baseband information modulated to the RF carrier and provides the baseband information to the receiving processor 452. The receiving processor 452 performs signal receiving processing functions of the layer 1, including the detection of the first signaling, the receiving of the second signaling, the receiving of a physical layer signal carrying the first-type information, the second-type information, and the first radio signal in the present application, etc. Demodulation is conducted corresponding to a modulation scheme (i.e., BPSK, QPSK, etc.) through the multi-carrier symbol in the multi-carrier symbol stream, then decoding and de-interleaving are conducted to recover the data or control signal transmitted by the gNB 410 on the physical channel, and then the data and control signal are provided to the controller/processor 490. The controller/processor 490 performs functions of the layer 2. The controller/processor can be connected to the memory 480 that stores program codes and datas. The memory 480 can be called a computer readable media.

In one embodiment, the UE 450 device includes at least one processor and at least one memory. The at least one memory includes computer program codes. The at least one memory and the computer program codes are configured to be used in collaboration with the at least one processor. The UE 450 device at least receives first-type information and detects a first signaling in X1 slots; wherein the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

In one embodiment, the UE 450 includes a memory that stores a computer readable instruction program. The computer readable instruction program generates an action when executed by at least one processor. The action includes receiving first-type information and detecting a first signaling in X1 slots; wherein the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

In one embodiment, the gNB 410 device includes at least one processor and at least one memory. The at least one memory includes computer program codes. The at least one memory and the computer program codes are configured to be used in collaboration with the at least one processor. The gNB 410 at least transmits first-type information and transmits a first signaling in X1 slots; wherein the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

In one embodiment, the gNB 410 device includes a memory that stores a computer readable instruction program. The computer readable instruction program generates an action when executed by at least one processor. The action includes transmitting first-type information and transmitting a first signaling in X1 slots; wherein the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

In one embodiment, the UE 450 corresponds to the UE in the present application.

In one embodiment, the gNB 410 corresponds to the base station device in the present application.

In one embodiment, the receiver 456 (including the antenna 460) and the receiving processor 452 are configured to monitor the first signaling in the present application.

In one embodiment, the receiver 456 (including the antenna 460), the receiving processor 452, and the controller/processor 490 are configured to monitor the first signaling in the present application.

In one embodiment, the receiver 456 (including the antenna 460) and the receiving processor 452 are configured to receive the second signaling in the present application.

In one embodiment, the receiver 456 (including the antenna 460), the receiving processor 452, and the controller/processor 490 are configured to receive the second signaling in the present application.

In one embodiment, the receiver 456 (including the antenna 460), the receiving processor 452, and the controller/processor 490 are configured to receive the first-type information in the present application.

In one embodiment, the receiver 456 (including the antenna 460), the receiving processor 452, and the controller/processor 490 are configured to receive the second-type information in the present application.

In one embodiment, the receiver 456 (including the antenna 460), the receiving processor 452, and the controller/processor 490 are configured to receive the first radio signal in the present application.

In one embodiment, the transmitter 416 (including the antenna 420) and the transmitting processor 415 are configured to transmit the first signaling in the present application.

In one embodiment, the transmitter 416 (including the antenna 420), the transmitting processor 415, and the controller/processor 440 are configured to transmit the first signaling in the present application.

In one embodiment, the transmitter 416 (including the antenna 420) and the transmitting processor 415 are configured to transmit the second signaling in the present application.

In one embodiment, the transmitter 416 (including the antenna 420), the transmitting processor 415, and the controller/processor 440 are configured to transmit the second signaling in the present application.

In one embodiment, the transmitter 416 (including the antenna 420), the transmitting processor 415, and the controller/processor 440 are configured to transmit the first-type information in the present application.

In one embodiment, the transmitter 416 (including the antenna 420), the transmitting processor 415, and the controller/processor 440 are configured to transmit the second-type information in the present application.

In one embodiment, the transmitter 416 (including the antenna 420), the transmitting processor 415, and the controller/processor 440 are configured to transmit the first radio signal in the present application.

### Embodiment 5

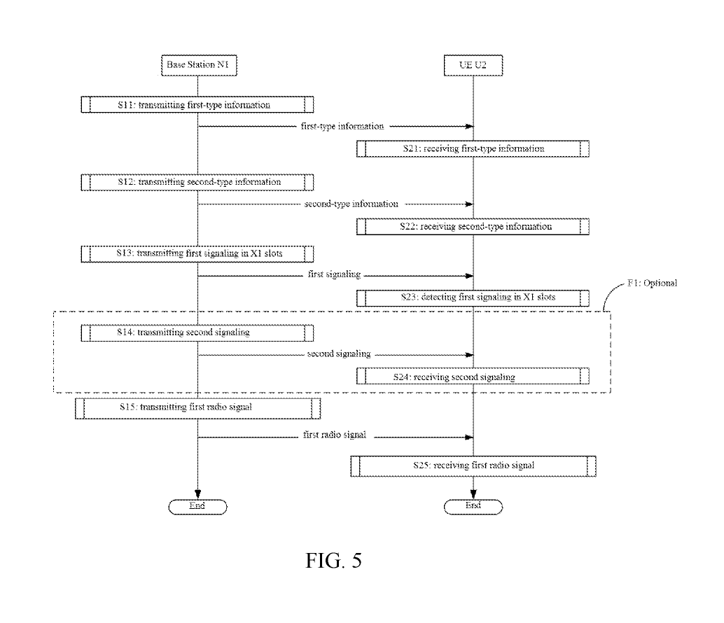

Embodiment 5 illustrates an example of a flowchart for the transmission of a radio signal according to an embodiment of the present application, as shown in FIG. 5. In FIG. 5, the base station N1 is a maintenance base station for a serving cell of the UE U2. Steps marked in a dotted box are optional.

The base station N1 transmits first-type information in S11, transmits second-type information in S12, transmits a first signaling in X1 slots in S13, transmits a second signaling in S14, and transmits a first radio signal in S15.

The UE U2 receives the first-type information in S21, receives the second-type information in S22, detects the first signaling in X1 slots in S23, receives the second signaling in S24, and receives the first radio signal in S25.

In Embodiment 5, the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information; the second-type information is used for determining K2 second-type time windows; and the first radio signal carries paging related information.

In one embodiment, each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the detector of the first signaling.

In one embodiment, the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

In one embodiment, the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1; the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the X candidate slots.

In one embodiment, the first signaling is used for determining at least one of {occupied time-frequency resource, MCS, subcarrier spacing of occupied subcarriers} of the first radio signal.

In one embodiment, the first signaling is used for determining whether the second signaling is transmitted, and the second signaling indicates at least one of {occupied time-frequency resource, MCS, subcarrier spacing of occupied subcarriers} of the first radio signal.

In one embodiment, the feature ID of the detector of the first signaling is further used for determining frequency domain resources occupied by the common search space included in the X1 slots.

In one embodiment, the second-type information is used by the UE to determine the K2 second-type time windows.

In one embodiment, the second-type information indicates the K2 second-type time windows.

In one embodiment, the second-type information includes the IEs in one RRC signaling.

In one embodiment, the second-type information includes partial or all of the IEs in one RRC signaling.

In one embodiment, the second-type information includes partial or all of the IEs in one MIB.

In one embodiment, the second-type information is transmitted through a PBCH.

In one embodiment, the second-type information includes partial or all of the IEs in one SIB.

In one embodiment, the second-type information includes partial or all of the IEs in one RMSI.

In one embodiment, the second-type information is transmitted through a PDSCH.

### Embodiment 6

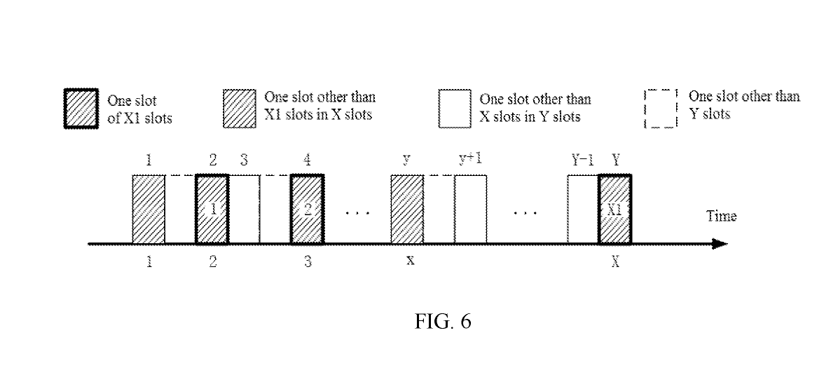

Embodiment 6 illustrates an example of a diagram of a relationship among X1 slots, X slots and Y slots according to one embodiment of the present disclosure, as shown in FIG. 6. In FIG. 6, the horizontal axis represents time, each small rectangle represents a slot, each small rectangle filled by slashes represents one slot of X slots, each small rectangle filled by slashes and having a thick border represents one slot of X1 slots, each small white rectangle having a solid box represents one slot other than X slots in Y slots, and each small rectangle having a dotted box represents one slot other than Y slots.

In Embodiment 6, a common search space is reserved within each of Y slots, each slot of the X1 slots is one of the Y slots, the feature ID of the UE in the present disclosure is used for determining the X1 slots among the Y slots, the Y is greater than the X1, and both the X1 and the Y are positive integers; each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the UE in the present disclosure.

In one embodiment, the feature ID of the UE in the present disclosure is used for determining the X1 slots among the X candidate slots.

In one embodiment, each slot of the X candidate slots is a candidate for PO.

In one embodiment, the Y is used by the UE to determine the X.

In one embodiment, the Y is used by the UE to determine the X according to a specific mapping relationship.

In one embodiment, the X is equal to the X1.

In one embodiment, the X is equal to the Y.

In one embodiment, the position of the X candidate slots in the Y slots being predefined refers that the position of the X candidate slots in the Y slots is fixed.

In one embodiment, the position of the X candidate slots in the Y slots being predefined refers that the position of the X candidate slots in the Y slots is predefined by a protocol.

In one embodiment, the feature ID of the detector of the first signaling in the present disclosure is used by the UE to determine the position of the X candidate slots among the Y slots according to a specific mapping relationship.

In one embodiment, the position of the X candidate slots in the Y slots is further related to the ID of a Tracking Area (TA) to which the detector of the first signaling belongs.

### Embodiment 7

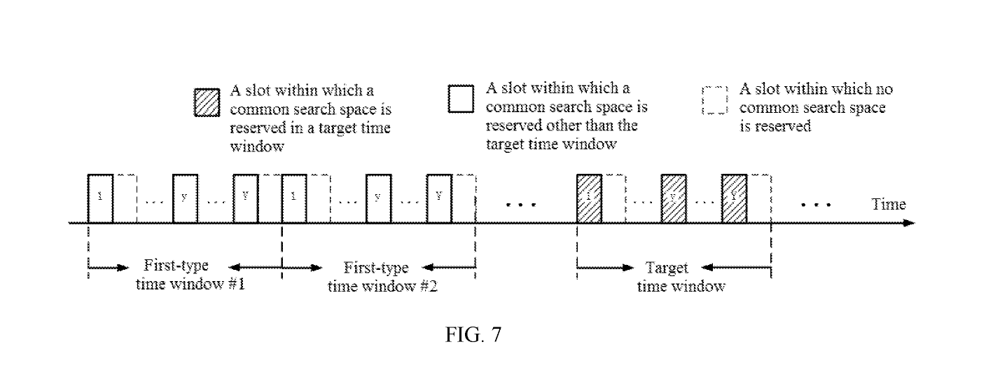

Embodiment 7 illustrates an example of a diagram of a relationship between a target time window and K1 first-type time windows according to one embodiment of the present disclosure, as shown in FIG. 7. In FIG. 7, the horizontal axis represents time, each small rectangle filled by slashes represents a slot within which a common search space is reserved in a target time window, each small white rectangle having a solid box represents a slot within which a common search space is reserved other than the target time window, and each small white rectangle having a dotted box represents a slot within which no common search space is reserved.

In Embodiment 7, a common search space is reserved within each of the Y slots, the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

In one embodiment, each first-type time window of the K1 first-type time windows includes Y slots within which a common search space is reserved.

In one embodiment, the first-type information is used for indicating in each first-type time window of the K1 first-type time windows the included Y slots.

In one embodiment, each first-type time window of the K1 first-type time windows includes Y slots within which a common search space is reserved, and, the Y slots included in each first-type time window of the K1 first-type time windows are at the same position in the corresponding first-type time window.

In one embodiment, the first-type information indicates in the target time window the Y slots.

In one embodiment, any two first-type time windows of the K1 first-type time windows are orthogonal in time.

In one embodiment, there is no time unit that belongs to two first-type time windows of the K1 first-type time windows simultaneously.

In one embodiment, the target time window includes more than Y slots, and the first-type information indicates in the target time window the Y slots.

In one embodiment, time lengths of the K1 first-type time windows are predefined or configured, and an appearing periodicity of the K1 first-type time windows is predefined or configured.

In one embodiment, any two time windows of the K1 first-type time windows have the same time duration.

In one embodiment, the time duration of each time window of the K1 first-type time windows is equal to an appearing periodicity of the K1 first-type time windows.

In one embodiment, the appearing periodicity of the K1 first-type time windows is a CSS periodicity.

In one embodiment, the appearing periodicity of the K1 first-type time windows is a PDCCH CSS periodicity.

In one embodiment, the appearing periodicity of the K1 first-type time windows is a PDCCH TYPE-I CSS periodicity.

In one embodiment, the appearing periodicity of the K1 first-type time windows is predefined to 10 ms.

In one embodiment, the appearing periodicity of the K1 first-type time windows is predefined to 40 ms.

In one embodiment, the feature ID of the detector of the first signaling is used by the UE to determine the target time window among the K1 first-type time windows.

In one embodiment, the feature ID of the detector of the first signaling is used by the UE to determine the target time window among the K1 first-type time windows according to a specific mapping relationship.

In one embodiment, the feature ID of the detector of the first signaling is used for determining the target time window among the K1 first-type time windows through the following formula:

PPN mod T=(T div N)*(UE_ID mod N)

Herein, PPN represents the ID or index of one first-type time window in the K1 first-type time windows; T presents a DRX or eDRX period configured for the UE; N=min(T,nB), where nB is a value configured by network; and UE_ID represents the feature ID of the detector of the first signaling.

### Embodiment 8

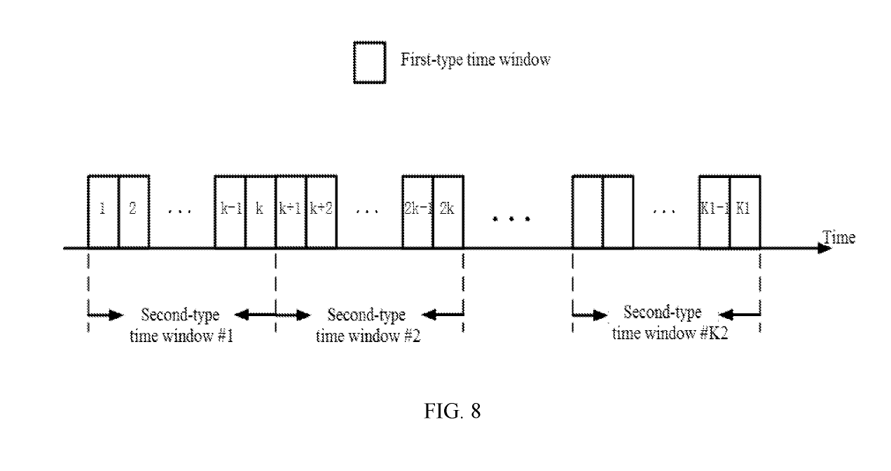

Embodiment 8 illustrates an example of a diagram of a relationship between K1 first-type time windows and K2 second-type time windows according to one embodiment of the present disclosure, as shown in FIG. 8. In FIG. 8, the horizontal axis represents time, and each small rectangle represents one first-type time window of K1 first-type time windows.

In Embodiment 8, K1 first-type time windows are evenly distributed over K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining, in the X candidate slots in the present disclosure, the X1 slots.

In one embodiment, there is no time unit that belongs to two second-type time windows of the K2 second-type time windows simultaneously.

In one embodiment, the K2 second-type time windows appear periodically.

In one embodiment, the K2 second-type time windows appear periodically, and the time duration of each second-type time window of the K2 second-type time windows is equal to the appearing periodicity of the K2 second-type time windows.

In one embodiment, each second-type time window of the K2 second-type time windows is a period of Discontinuous Reception (DRX).

In one embodiment, each second-type time window of the K2 second-type time windows is a period of enhanced Discontinuous Reception (eDRX).

In one embodiment, the K2 is equal to the K1.

In one embodiment, the amount of first-type time windows among the K1 first-type time windows, which are contained in each second-type time window of the K2 second-type time windows, is used for determining the X1 slots among the X candidate slots through the following formula:

i_s=floor(UE_ID/N) mod Ns

Herein, i_s is the ID of one slot of the X1 slots in the X candidate slots; UE_ID is the feature ID of the detector of the first signaling; N=min(T,nB), where T is the number of the first-type time window in the K1 first-type time windows included in each second-type time window of the K2 second-type time windows, and nB is a value configured by the network side; and Ns=max(1,nB/T).

### Embodiment 9

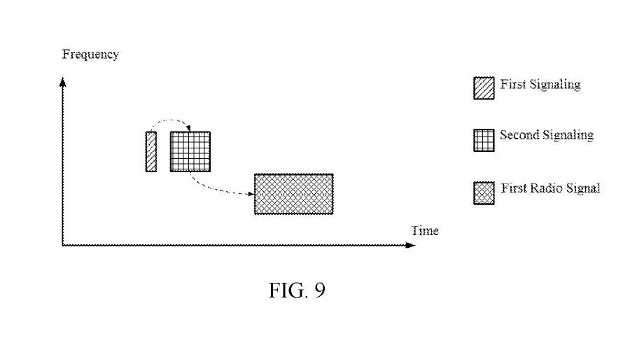

Embodiment 9 illustrates an example of a diagram of a relationship among a first signaling, a second signaling and a first radio signal according to one embodiment of the present disclosure, as shown in FIG. 9. In FIG. 9, the rectangle filled by slashes represents time-frequency resources occupied by a first signaling, the rectangle filled by cross lines represents time-frequency resources occupied by a second signaling, and the rectangle filled by oblique cross lines represents time-frequency resources occupied by a first radio signal.

In Embodiment 9, a first radio signal carries paging related information; a first signaling indicates scheduling information of the first radio signal; or the first signaling is used for determining whether a second signaling is transmitted, and the second signaling indicates scheduling information of the first radio signal; the scheduling information includes at least one of {occupied time-frequency resource, MCS, subcarrier spacing of occupied subcarriers}; and a feature ID of a detector of the first signaling is further used for determining frequency domain resources occupied by the common search space included in the X1 slots in the present disclosure.

In one embodiment, a transmission channel corresponding to the first radio signal is a Paging Channel (PCH).

In one embodiment, the first radio signal is transmitted through a PDSCH.

In one embodiment, the MCS of the first radio signal is one of the MCSs supported by the downlink data channels in 5G NR.

In one embodiment, the subcarrier spacing of every subcarrier occupied by the first radio signal is equal.

In one embodiment, the subcarrier spacing of subcarriers occupied by the first radio signal is one of {7.5 kHz, 15 kHz, 30 kHz, 60 kHz, 120 kHz, 240 kHz, 480 kHz}.

In one embodiment, the first signaling is used by the UE to determine at least one of {occupied time-frequency resource, MCS, subcarrier spacing of occupied subcarriers} of the first radio signal.

In one embodiment, the first signaling indicates at least one of {occupied time-frequency resource, MCS, subcarrier spacing of occupied subcarriers} of the first radio signal.

In one embodiment, the first signaling includes a wake-up signal, and the second signaling includes a DCI.

In one embodiment, the first signaling includes a wake-up signal, and the second signaling is transmitted through a PDCCH.

In one embodiment, whether the second signaling is transmitted is determined through the energy detection of the first signaling.

In one embodiment, whether the second signaling is transmitted is determined through whether the first signaling is transmitted.

In one embodiment, whether the second signaling is transmitted is determined through the sliding correlation detection of the first signaling.

In one embodiment, the frequency domain resource occupied by the common search space included in the X1 slots is one of a positive integer number of predefined or configured frequency bands.

In one embodiment, the frequency domain resource occupied by the common search space included in the X1 slots is one of a positive integer number of predefined or configured Bandwidth Parts (BWPs).

In one embodiment, the feature ID of the detector of the first signaling is used by the UE to determine the frequency domain resources occupied by the common search space included in the X1 slots.

In one embodiment, the feature ID of the detector of the first signaling is used by the UE to determine, according to a specific mapping relationship, the frequency domain resources occupied by the common search space included in the X1 slots.

In one embodiment, the feature ID of the detector of the first signaling is used by the UE to determine the frequency domain resources occupied by the common search space included in the X1 slots through the following formula:

BWP=floor(UE_ID/(N*Ns)) mod Nn

Herein, BWP represents the ID of the frequency domain resources occupied by the common search space included in the X1 slots in a positive integer number of frequency bands or BWPs; UE_ID is the feature ID of the detector of the first signaling; N=min(T,nB), where T is a configured DRX or eDRX period, and nB is a value configured by the network side; Ns=max(1,nB/T); and Nn is the number of frequency bands or BWPs for paging or the number of carriers for paging.

### Embodiment 10

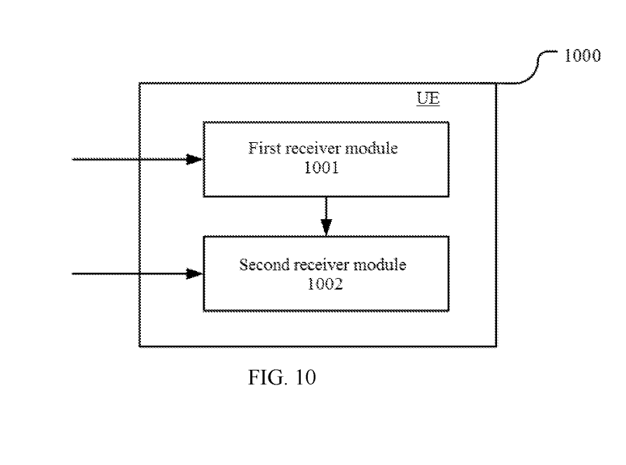

Embodiment 10 illustrates an example of a structure block diagram of a processing device in a UE, as shown in FIG. 10. In FIG. 10, the processing device 1000 in the UE is mainly composed of a first receiver module 1001 and a second receiver module 1002. The first receiver module 1001 includes the transmitter/receiver 456 (including antenna 460), the receiving processor 452, and the controller/processor 490 shown in FIG. 4 of the present disclosure; and the second receiver module 1002 includes the transmitter/receiver 456 (including antenna 460), the receiving processor 452, and the controller/processor 490 shown in FIG. 4 of the present disclosure.

In Embodiment 10, the first receiver module 1001 receives first-type information, and the second receiver module 1002 detects a first signaling in X1 slots; wherein the first-type information is used for determining Y slots, a common search space is reserved within each of the Y slots, each slot of the X1 slots is one of the Y slots, a feature ID of a detector of the first signaling is used for determining in the Y slots the X1 slots, the Y is greater than the X1, both the X1 and the Y are positive integers, and the first signaling is used for determining paging related information.

In one embodiment, each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the detector of the first signaling.

In one embodiment, the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

In one embodiment, the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1; the first receiver module 1001 further receives second-type information; wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the X candidate slots.

In one embodiment, the second receiver module 1002 further receives a first radio signal; wherein the first radio signal carries paging related information, and the first signaling is used for determining at least one of {occupied time-frequency resource, MCS, subcarrier spacing of occupied subcarriers} of the first radio signal.

In one embodiment, the second receiver module 1002 further receives a first radio signal and a second signaling; wherein the first signaling is used for determining whether the second signaling is transmitted, and the second signaling indicates at least one of {occupied time-frequency resource, MCS, subcarrier spacing of occupied subcarriers} of the first radio signal.

In one embodiment, the feature ID of the detector of the first signaling is further used for determining frequency domain resources occupied by the common search space included in the X1 slots.

### Embodiment 11

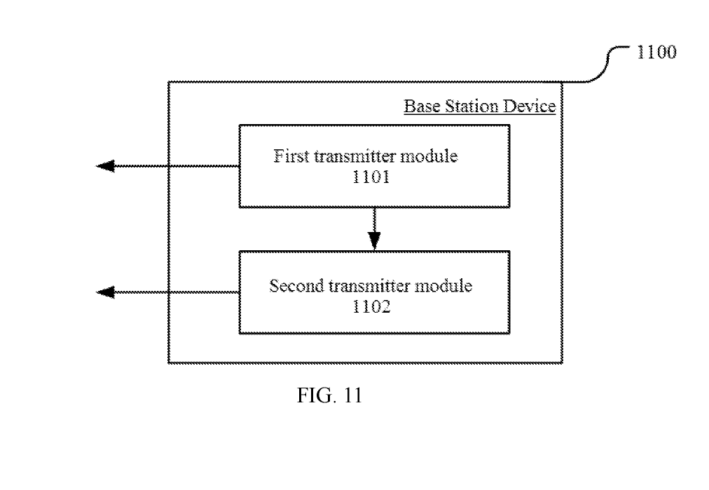

Embodiment 11 illustrates an example of a structure block diagram of a processing device in a base station, as shown in FIG. 11. In FIG. 11, the processing device 1100 in the base station is mainly composed of a first transmitter module 1101 and a second transmitter module 1102. The first transmitter module 1101 includes the transmitter/receiver 416 (including antenna 420), the transmitting processor 415, and the controller/processor 440 shown in FIG. 4 of the present disclosure; and the second transmitter module 1102 includes the transmitter/receiver 416 (including antenna 420), the transmitting processor 415, and the controller/processor 440 shown in FIG. 4 of the present disclosure.

In Embodiment 11, the first transmitter module 1101 transmits first-type information, and the second transmitter module 1102 transmits a first signaling in X1 slots; wherein the first-type information is used for determining Y slots, a common search space is reserved within each of the Y slots, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

In one embodiment, each slot of the X1 slots is one of X candidate slots, each candidate slot of the X candidate slots is one of the Y slots, the X is a positive integer not less than the X1, the X is not greater than the Y, and the Y is used for determining the X; and the position of the X candidate slots in the Y slots is predefined, or, the position of the X candidate slots in the Y slots is related to the feature ID of the detector of the first signaling.

In one embodiment, the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

In one embodiment, the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1; the first transmitter module 1101 further transmits second-type information; wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows is used for determining the X1 slots among the X candidate slots.

In one embodiment, the second transmitter module 1102 further transmits a first radio signal; wherein, the first radio signal carries paging related information, and the first signaling is used for determining at least one of {occupied time-frequency resource, MCS, subcarrier spacing of occupied subcarriers} of the first radio signal.

In one embodiment, the second transmitter module 1102 further transmits a second signaling and a first radio signal; wherein the first signaling is used for determining whether the second signaling is transmitted, and the second signaling indicates at least one of {occupied time-frequency resource, MCS, subcarrier spacing of occupied subcarriers} of the first radio signal.

In one embodiment, the feature ID of the detector of the first signaling is further used for determining frequency domain resources occupied by the common search space included in the X1 slots.

The ordinary skill in the art may understand that all or part steps in the above method may be implemented by instructing related hardware through a program. The program may be stored in a computer readable storage medium, for example Read-Only Memory (ROM), hard disk or compact disc, etc. Optionally, all or part steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The UE or terminal in the present disclosure includes but not limited to mobile phones, tablet computers, notebooks, network cards, low-power equipment, eMTC equipment, NB-IoT equipment, vehicle-mounted communication equipment, and other wireless communication equipment. The base station or network side equipment in the present disclosure includes but not limited to macro-cellular base stations, micro-cellular base stations, home base stations, relay base station, eNB, gNB, TRP, and other wireless communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A method in a User Equipment (UE) for wireless communication, comprising:
receiving first-type information; and
detecting a first signaling in X1 slots;
wherein the first-type information is used for determining Y slots, a common search space is reserved within each of the Y slots for Downlink Control Information (DCI) that can be used to schedule paging related information, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

2. The method according to claim 1, wherein the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

3. The method according to claim 2, further comprising:
receiving second-type information;
wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the Y slots.

4. The method according to claim 1, further comprising:
receiving a first radio signal;
wherein the first radio signal carries paging related information, and the first signaling indicates time-frequency resources occupied by the first radio signal and a Modulation and Coding Scheme (MCS) of the first radio signal.

5. The method according to claim 1, wherein transmissions respectively within any two slots of the X1 slots are Quasi Co-Located (QCLed) with different Synchronization Signal Broadcast Blocks (SS/PBCH Blocks).

6. A method in a base station device for wireless communication, comprising:
transmitting first-type information; and
transmitting a first signaling in X1 slots;
wherein the first-type information is used for determining Y slots, a common search space is reserved within each of the Y slots for DCI that can be used to schedule paging related information, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

7. The method according to claim 6, wherein the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

8. The method according to claim 7, further comprising:
transmitting second-type information;
wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the Y slots.

9. The method according to claim 6, further comprising:
transmitting a first radio signal;
wherein the first radio signal carries paging related information, and the first signaling indicates time-frequency resources occupied by the first radio signal and an MCS of the first radio signal.

10. The method according to claim 6, wherein transmissions respectively within any two slots of the X1 slots are QCLed with different SS/PBCH Blocks.

11. A UE for wireless communication, comprising:
a first receiver module, to receive first-type information; and
a second receiver module, to detect a first signaling in X1 slots;
wherein the first-type information is used for determining Y slots, a common search space is reserved within each of the Y slots for DCI that can be used to schedule paging related information, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

12. The UE according to claim 11, wherein the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

13. The UE according to claim 12, wherein the first receiver module further receives second-type information; wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows, is used for determining the X1 slots among the Y slots.

14. The UE according to claim 11, wherein the second receiver module further receives a first radio signal; wherein the first radio signal carries paging related information, and the first signaling indicates time-frequency resources occupied by the first radio signal and an MCS of the first radio signal.

15. The UE according to claim 11, wherein transmissions respectively within any two slots of the X1 slots are QCLed with different SS/PBCH Blocks.

16. A base station device for wireless communication, comprising:
a first transmitter module, to transmit first-type information; and
a second transmitter module, to transmit a first signaling in X1 slots;
wherein the first-type information is used for determining Y slots, a common search space is reserved within each of the Y slots for DCI that can be used to schedule paging related information, each slot of the X1 slots is one of the Y slots, a feature ID of a detector of the first signaling is used for determining the X1 slots among the Y slots, the Y is greater than the X1, both the X1 and the Y are positive integers, and the first signaling is used for determining paging related information.

17. The base station device according to claim 16, wherein the Y slots belong to a target time window, the target time window is one of K1 first-type time windows, the K1 first-type time windows appear periodically, and an appearing periodicity of the K1 first-type time windows is predefined or configured; and the feature ID of the detector of the first signaling is used for determining the target time window among the K1 first-type time windows, and the K1 is a positive integer greater than 1.

18. The base station device according to claim 17, wherein the first transmitter module further transmits second-type information; wherein the second-type information is used for determining K2 second-type time windows, the K1 first-type time windows are evenly distributed over the K2 second-type time windows, any two second-type time windows of the K2 second-type time windows are orthogonal, the K2 is a positive integer multiple of the K1, an amount of first-type time windows among the K1 first-type time windows, which are contained in each second-type time window of the K2 second-type time windows is used for determining the X1 slots among the Y slots.

19. The base station device according to claim 16, wherein the second transmitter module further transmits a first radio signal; wherein the first radio signal carries paging related information, and the first signaling indicates time-frequency resources occupied by the first radio signal and an MCS of the first radio signal.

20. The base station device according to claim 16, wherein transmissions respectively within any two slots of the X1 slots are QCLed with different SS/PBCH Blocks.
